(19) United States
(12) Patent Application Publication
(10) Pub. No.: US 2015/0305097 A1
(43) Pub. Date: Oct. 22, 2015

(54) MICROWAVE HEATING APPARATUS AND MICROWAVE HEATING METHOD

(71) Applicant: TOKYO ELECTRON LIMITED, Tokyo (JP)

(72) Inventors: Mitsutoshi ASHIDA, Yamanashi (JP); Seokhyoung HONG, Yamanashi (JP)

(73) Assignee: TOKYO ELECTRON LIMITED, Tokyo (JP)

(21) Appl. No.: 14/684,865

(22) Filed: Apr. 13, 2015

(30) Foreign Application Priority Data
Apr. 21, 2014 (JP) 2014-087266

(51) Int. Cl. H05B 6/80; H05B 6/64

(52) U.S. Cl. CPC H05B 6/80; H05B 6/645; H05B 6/6408

(57) ABSTRACT

A microwave heating apparatus includes: a processing chamber including a ceiling wall and a bottom wall and accommodating a target object; a microwave introducing unit to generate a microwave for heating the target object; a holding unit to hold the target object; and a control unit to control the microwave introducing unit to heat the target object. During heating the target object, the holding unit holds the target object at a position in which a distance H1 from the top surface of the bottom wall to the bottom surface of the target object satisfies a condition of H1<λ/2, and a distance H2 from the bottom surface of the ceiling wall to the top surface of the target object satisfies a condition of 3λ/4≦H2<λ, λ being a microwave wavelength.

### CROSS-REFERENCE TO RELATED APPLICATION

This application claims priority to Japanese Patent Application No. 2014-087266 filed on Apr. 21, 2014, the entire contents of which are incorporated herein by reference.

### FIELD OF THE INVENTION

The disclosure relates to a microwave heating apparatus and a microwave heating method for heating a substrate by introducing microwaves into a processing chamber.

### BACKGROUND OF THE INVENTION

Recently, an apparatus using microwaves is suggested as an apparatus for heating a substrate such as a semiconductor wafer or the like. A heating apparatus using microwaves can perform internal heating, local heating and selective heating and thus provides enhanced processing efficiency, compared to a conventional annealing apparatus of a lamp heating type or a resistance heating type. For example, when doping atoms are activated by using microwave heating, the microwaves directly act on the doping atoms. Therefore, it is advantageous in that excessive heating does not occur and expansion of the diffusion layer can be suppressed. Further, the heating using microwave irradiation is advantageous in that a heating process can be performed at a relatively low temperature and an increase in a thermal budget can be suppressed compared to the conventional lamp heating or resistance heating.

As for the heating apparatus using microwaves, there is suggested in, e.g., Japanese Patent Application Publication No. H3-233888 (e.g., FIG. 1), a microwave irradiation unit in which conductive protrusions are provided on a part of a surface of a conductive guide plate to uniformly heat a target object.

Microwave has a long wavelength of several tens of millimeters and easily forms standing waves in the processing chamber. Accordingly, when the semiconductor wafer is heated by using the microwave, e.g., an intensity distribution of an electromagnetic field becomes non-uniform in the surface of the semiconductor wafer, which is likely to result in non-uniform heating temperature.

### SUMMARY OF THE INVENTION

In view of the above, the disclosure provides a microwave heating apparatus and a microwave heating method capable of uniformly and effectively heating a target object.

In accordance with an aspect of the disclosure, there is provided a microwave heating apparatus including: a processing chamber configured to accommodate a target object, the processing chamber including a ceiling wall, a bottom wall in parallel with the ceiling wall, and a sidewall; a microwave introducing unit including one or more microwave introduction ports formed at the ceiling wall and configured to generate a microwave for heating the target object and to introduce the microwave into the processing chamber through the one or more microwave introduction ports; and a holding unit configured to hold the target object to be opposite to the ceiling wall in the processing chamber.

The microwave heating apparatus further includes a control unit configured to control the microwave introducing unit to heat the target object while controlling the holding unit to hold the target object at one vertical position in which a first distance H1 from the top surface of the bottom wall to the bottom surface of the target object satisfies a condition of H1<λ/2, and a second distance H2 from the bottom surface of the ceiling wall to the top surface of the target object satisfies a condition of 3λ/4≦H2<λ, λ being a wavelength of the microwave.

In accordance with another aspect of the disclosure, there is provided a microwave heating method for use in heating a target object in a processing chamber including a ceiling wall and a bottom wall in parallel to the ceiling wall. The microwave heating method includes: heating the target object while holding the target object at one vertical position in which a first distance H1 from a top surface of the bottom wall to a bottom surface of the target object satisfies a condition of H1<λ/2, and a second distance H2 from a bottom surface of the ceiling wall to a top surface of the target object satisfies a condition of 3λ/4≦H2<λ, λ being a wavelength of the microwave.

### BRIEF DESCRIPTION OF THE DRAWINGS

The objects and features of the disclosure will become apparent from the following description of embodiments, given in conjunction with the accompanying drawings, in which:

FIG. 1 is a cross sectional view showing a schematic configuration of a microwave heating apparatus used in a microwave heating method in accordance with an embodiment;

FIG. 2 is a plan view showing a bottom surface of a ceiling wall of the processing chamber shown in FIG. 1;

FIG. 3 is a perspective view of a holder for holding a target object in the microwave heating apparatus shown in FIG. 1;

FIG. 4 is a view for explaining a vertical position of the holder in the processing chamber shown in FIG. 1;

FIG. 5 is a view for explaining a schematic configuration of a high voltage power supply unit of the microwave heating apparatus shown in FIG. 1;

FIG. 6 is a block diagram showing a hardware configuration of a control unit;

FIG. 7 is a flowchart showing an exemplary sequence of a microwave heating method in accordance with an embodiment;

FIG. 8 is a graph showing a change of a carrier density during a process of increasing a temperature of a silicon substrate;

FIG. 9 is a graph showing changes of a temperature and a reflection wave in the case of heating a semiconductor wafer in a microwave heating apparatus having the same configuration as that shown in FIG. 1;

FIG. 10 is a schematic diagram for explaining a vertical position of a semiconductor wafer in the processing chamber; and

FIG. 11 is another schematic diagram for explaining a vertical position of the semiconductor wafer in the processing chamber.

### DETAILED DESCRIPTION OF THE EMBODIMENTS

Hereinafter, embodiments will be described in detail with reference to the accompanying drawings.

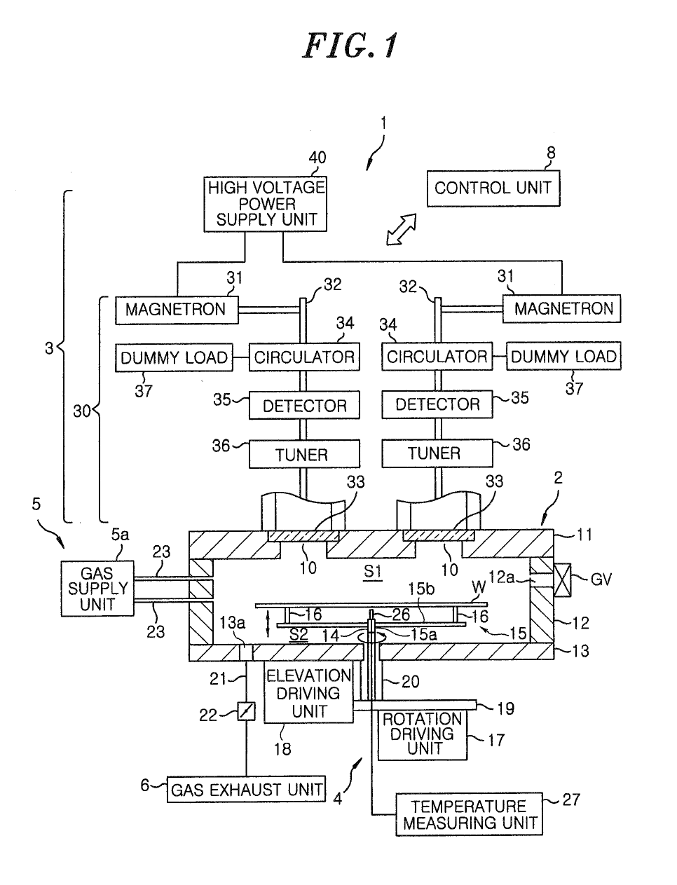

First, a microwave heating apparatus in accordance with an embodiment will be described with reference to FIG. 1. The microwave heating apparatus 1 performs, through a plurality of consecutive operations, a heating process by irradiating microwaves onto a semiconductor wafer (hereinafter, simply referred to as “wafer”) used for manufacturing semiconductor devices. The flat plate-shaped wafer W has a top surface and a bottom surface of large areas. Semiconductor devices are formed on the top surface and, thus, processing is performed thereto.

The microwave heating apparatus 1 includes: a processing chamber 2 for accommodating a wafer W that is a target object; a microwave introducing unit 3 for introducing microwaves into the processing chamber 2; a supporting unit 4 for supporting the wafer W at a position opposite to the ceiling wall 11 in the processing chamber 2; a gas supply mechanism 5 for supplying a gas into the processing chamber 2; a gas exhaust unit 6 for vacuum-exhausting the processing chamber 2; and a control unit 8 for controlling the respective components of the microwave heating apparatus 1.

(Processing Chamber)

The processing chamber 2 is made of a metal, e.g., aluminum, aluminum alloy, stainless steel or the like. The microwave introducing unit 3 is provided above the processing chamber 2 and serves as a unit for introducing electromagnetic waves (microwaves) into the processing chamber 2. The configuration of the microwave introducing unit 3 will be later described in detail.

The processing chamber 2 includes: the plate-shaped ceiling wall 11; a plate-shaped bottom wall 13; four sidewalls 12 that connect the ceiling wall 11 and the bottom wall 13; a plurality of microwave introduction ports 10 vertically penetrating through the ceiling wall 11; a loading/unloading port 12a provided at the sidewall 12; and a gas exhaust port 13a provided at the bottom wall 13. The four sidewalls 12 are connected at right angles when seen from the top, thereby forming a polygonal shape. Thus, the processing chamber 2 has a cubical shape having a hollow inner space. The inner surface of each of the sidewalls 12 is flat and serves as a reflective surface for reflecting the microwaves.

The loading/unloading port 12a allows the wafer W to be transferred between the processing chamber 2 and a transfer chamber (not shown) adjacent thereto. A gate valve GV is provided between the processing chamber 2 and the transfer chamber. The gate valve GV has a function of opening and closing the loading/unloading port 12a. When the gate valve GV is closed, the processing chamber 2 is airtightly sealed. When the gate valve GV is opened, the wafer W can be transferred between the processing chamber 2 and the transfer chamber.

(Supporting Unit)

As shown in FIGS. 1 and 3, the supporting unit 4 includes: a tubular shaft 14 that penetrates through substantially the center of the bottom wall 13 of the processing chamber 2 to extend to the outside of the processing chamber 2, and a holder 15 serving as a holding unit provided at an upper end portion of the shaft 14. The holder 15 includes a holder base portion 15a provided at an upper end portion of the shaft 14; a plurality of (three in the present embodiment) arms 15b arranged radially from the holder base portion 15a in a substantially horizontal direction; and a plurality of supporting pins 16 detachably provided at the respective arms 15b.

The supporting pins 16 come in contact with the backside of the wafer W to support the wafer W in the processing chamber 2. The supporting pins 16 are disposed such that the upper end portions thereof are arranged along the circumferential direction of the wafer W. The supporting pins 16 are detachably attached to the arms 15b. The number of the arms 15b and the number of the supporting pins 16 are not particularly limited as long as the wafer W can be stably supported. The holder 15 is made of a dielectric material. As for the dielectric material, it is possible to use, e.g., quartz, ceramic or the like.

The supporting unit 4 further includes a rotation driving unit 17 for rotating the shaft 14; an elevation driving unit 18 for vertically moving the shaft 14; and a movable connection unit 19 for supporting the shaft 14 and connecting the rotation driving unit 17 and the elevation driving unit 18. The rotation driving unit 17, the elevation driving unit 18 and the movable connection unit 19 are provided at the outside of the processing chamber 2. When the inside of the processing chamber 2 needs to be in a vacuum state, a sealing device 20, e.g., a bellows or the like, may be provided around the portion where the shaft 14 penetrates through the bottom wall 13.

In the supporting unit 4, the shaft 14, the holder 15, the rotation drive unit 17 and the movable connection unit 19 constitute a rotation mechanism for rotating the wafer W in a horizontal plane. By driving the rotation drive unit 17, the holder 15 is rotated about the shaft 14 to allow each of the supporting pins 16 to be circularly moved (revolved) horizontally. The rotation driving unit 17 is not particularly limited as long as it can rotate the shaft 14. For example, the rotation driving unit 17 may have a motor (not shown) or the like.

Further, in the supporting unit 4, the shaft 14, the holder 15, the elevation drive unit 18 and the movable connection unit 19 constitute a vertical position adjusting mechanism for controlling a vertical position of the wafer W. By driving the elevation drive unit 18, the holder 15 is vertically moved together with the shaft 14. The elevation driving unit 18 is not particularly limited as long as it can vertically move the shaft 14 and the movable connection unit 19. For example, the elevation driving unit 18 may have a ball screw (not shown) or the like.

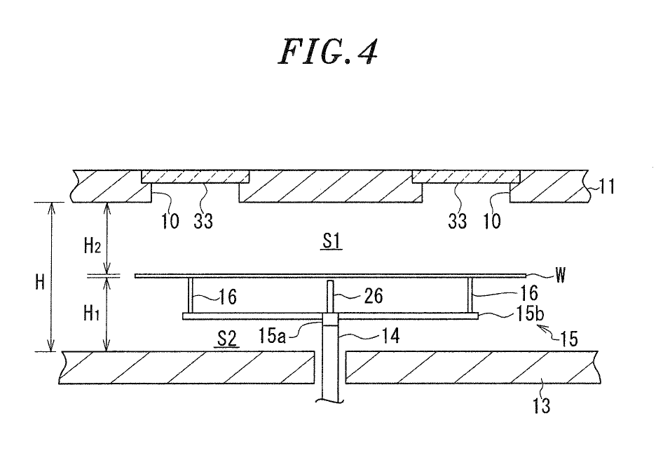

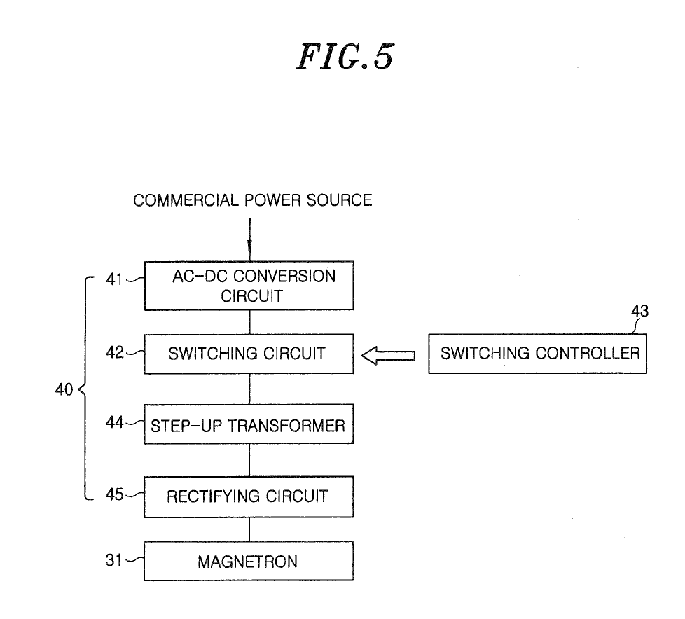

In the microwave heating apparatus 1 in accordance with the present embodiment, the wafer W can be held at a predetermined height by the holder 15 of the supporting unit 4. A vertical position where the wafer W is held by the holder 15 can be variably controlled. Referring to FIG. 4, e.g., the holder 15 can hold the wafer W at a vertical position in which a distance H1 from the top surface of the bottom wall 13 to the backside of the wafer W satisfies a condition of H1<λ/2 and a distance H2 from the bottom surface of the ceiling wall 11 to the top surface of the wafer W satisfies a condition of 3λ/4≦H2<λ, λ being a vacuum wavelength of the microwave (which may be simply referred to as “wavelength”). This vertical position corresponds to a first vertical position in the disclosure. If a thickness of the wafer W (about 0.6 mm) is not considered, the sum of the distance H1 and the distance H2 is equal to the entire height H of the processing chamber 2 (i.e., the distance from the bottom surface of the ceiling wall 11 to the top surface of the bottom wall 13).

At the first vertical position, the distance H1 is smaller than λ/2. Therefore, at a temperature range of, e.g., 400° C. or above, standing waves having a wavelength in a vertical direction of the processing chamber 2 (which may be referred to as “standing waves in the vertical direction” hereinafter) are not generated in a space S2 below the wafer W (a space from the top surface of the bottom wall 13 to the backside of the wafer W). On the other hand, standing waves other than the standing waves in the vertical direction, e.g., standing waves in a direction parallel to the top surface or the backside of the wafer W, can be generated in the space S2 below the wafer W. In the present embodiment, the distance H1 is set so that the condition of H1<λ/2 is satisfied and the standing waves in the vertical position are prevented from being generated in the space S2 below the wafer W. Accordingly, types of the standing waves generated in the space S2 below the wafer W are reduced. As a result, the variation of the standing waves can be prevented.

At the first vertical position, the distance H2 is greater than or equal to 3λ/4 and smaller than λ. Therefore, at the temperature range of, e.g., 400° C. or above, a single standing wave in a vertical direction is allowed to be generated in a space S1 above the wafer W (a space from the bottom surface of the ceiling wall 11 to the top surface of the wafer W). Accordingly, the microwaves introduced through the microwave introduction ports 10 of the ceiling wall 11 are effectively irradiated toward the wafer W in the space S1 above the wafer W. Further, by satisfying the condition of 3λ/4≦H2<λ, the microwaves easily propagate in a direction parallel to the top surface of the wafer W and, thus, the wavelength of the standing waves in a direction parallel to the top surface of the wafer W can be shortened. Accordingly, the wafer W can be uniformly heated at a position of an antinode where an electric field is strong. As a result, the uniformity of the heating temperature in the surface of the wafer W can be improved.

The variation of the standing waves in the spaces above and below the wafer W deteriorates the uniformity of the heating temperature in the surface of the wafer W. In the microwave heating apparatus 1 in accordance with the present embodiment, the behavior of the standing waves in the spaces above and below the wafer W is controlled by holding the wafer W at the first vertical position by the holder 15. Accordingly, the variation of the standing waves is suppressed. As a result, the uniformity of the heating temperature in the surface of the wafer W can be improved.

The holder 15 may set the wafer W at another vertical position other than the first vertical position. For example, the wafer W can be held at a second vertical position (H1=H2) in which the distance H1 from the top surface of the bottom wall 13 to the backside of the wafer W becomes equal to the distance H2 from the bottom surface of the ceiling wall 11 to the top surface of the wafer W. This vertical position is at the middle of the distance between the ceiling wall 11 and the bottom wall 12 in the processing chamber 2 (which may be referred to as an “intermediate position” hereinafter). At the intermediate position, the wafer W can be located at the position of the antinode of the standing wave where the electric field in the processing chamber 2 is strong in a temperature range from a room temperature to 400° C., for example. Accordingly, heating efficiency of the wafer W is increased. As a result, a heating rate can be improved.

The rotation mechanism for horizontally rotating the wafer W and the vertical position adjusting mechanism for controlling the vertical position of the wafer W may have other configurations as long as the functions thereof can be realized. The rotation driving unit 17 and the elevation driving unit 18 may be formed as one unit, or the movable connection unit 19 may not be provided.

(Gas Exhaust Unit)

The gas exhaust unit 6 may have a vacuum pump, e.g., a dry pump or the like. The microwave heating apparatus 1 further includes a gas exhaust line 21 for connecting the gas exhaust port 13a and the gas exhaust unit 6, and a pressure control valve 22 disposed on the gas exhaust line 21. By operating the vacuum pump of the gas exhaust unit 6, the inner space of the processing chamber 2 is vacuum-exhausted. The microwave heating apparatus 1 may perform processing under the atmospheric pressure. In this case, the vacuum pump may be omitted. As for the gas exhaust unit 6, a gas exhaust equipment provided at a facility where the microwave heating apparatus 1 is installed may be used instead of the vacuum pump such as a dry pump or the like.

(Gas Supply Mechanism)

The microwave heating apparatus 1 further includes a gas supply mechanism 5 for supplying a gas into the processing chamber 2. The gas supply mechanism 5 includes: a gas supply unit 5a having a gas supply source (not shown); and a plurality of lines 23 (only two are shown), connected to the gas supply unit 5a, for introducing a processing gas into the processing chamber 2. The lines 23 are connected to the sidewall 12 of the processing chamber 2.

The gas supply unit 5a is configured to supply a processing gas, e.g., N₂, Ar, He, Ne, O₂, H₂ or the like, into the processing chamber 2 through the lines 23 in a side flow manner. Alternatively, a gas supply unit may be provided at a position opposite to the wafer W (e.g., the ceiling wall 11) to supply the gas into the processing chamber 2. Instead of the gas supply unit 5a, an external gas supply unit that is not included in the configuration of the microwave heating apparatus 1 may be used. Although it is not illustrated, the microwave heating apparatus 1 further includes mass flow controllers and opening/closing valves which are provided on the gas supply lines 23. The types or the flow rates of the gases supplied into the processing chamber 2 are controlled by the mass flow controllers and the opening/closing valves.

(Temperature Measurement Unit)

The microwave heating apparatus 1 further includes a plurality of radiation thermometers 26 for measuring a surface temperature of the wafer W, and a temperature measurement unit 27 connected to the radiation thermometers 26. In FIG. 1, among the radiation thermometers 26, the radiation thermometer 26 for measuring a surface temperature of the central portion of the wafer W is only shown.

(Microwave Radiation Space)

In the microwave heating apparatus 1 in accordance with the present embodiment, a space defined by the ceiling wall 11, the four sidewalls 12 and the bottom wall 13 in the processing chamber 2 forms a microwave radiation space. Microwaves are radiated into the microwave radiation space through the microwave introduction ports 10 provided at the ceiling wall 11. Since each of the ceiling wall 11, the four sidewalls 12 and the bottom wall 13 of the processing chamber 2 is made of a metal, the microwaves are reflected thereby to be scattered in the microwave radiation space.

(Microwave Introducing Unit)

Hereinafter, the configuration of the microwave introducing unit 3 will be described with reference to FIGS. 1, 2 and 5. FIG. 5 is a view for explaining a schematic configuration of a high voltage power supply unit of the microwave introducing unit 3. As described above, the microwave introducing unit 3 is provided above the processing chamber 2 and introduces electromagnetic waves (microwaves) into the processing chamber 2. As shown in FIG. 1, the microwave introducing unit 3 includes a plurality of microwave units 30 for introducing microwaves into the processing chamber 2, and a high voltage power supply unit 40 connected to the microwave units 30.

(Microwave Unit)

In the present embodiment, each of the microwave units 30 has the same configuration. Each of the microwave units 30 includes: a magnetron 31 for generating microwaves for processing the wafer W; a waveguide 32 through which the microwaves generated by the magnetron 31 are transmitted to the processing chamber 2; and a transmitting window 33 that is fixed to the ceiling wall 11 to cover the microwave introduction ports 10. The magnetron 31 serves as a microwave source in the present embodiment.

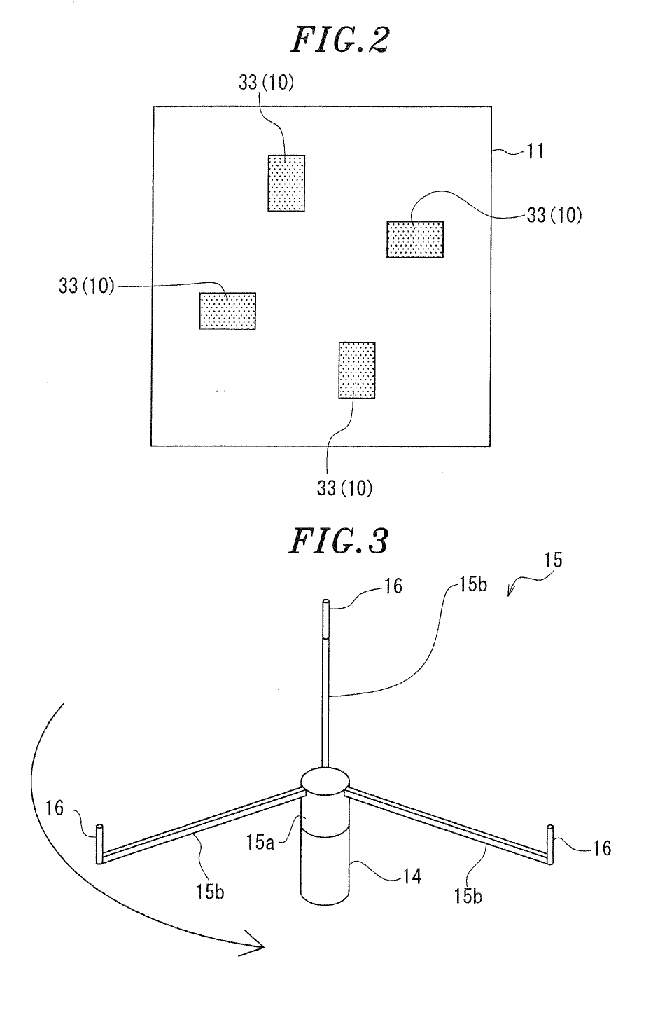

As shown in FIG. 2, in the present embodiment, the processing chamber 2 has four microwave introduction ports 10 that are provided at the ceiling wall 11 and spaced apart from each other at a regular interval along a circumferential direction thereof. Each of the microwave introduction ports 10 is formed in a rectangular shape having shorts sides and long sides when seen from the top. Although the microwave introduction ports 10 may have different sizes or different ratios between the long sides and the short sides, it is preferable that all the four microwave introduction ports 10 have the same size and the same shape in order to increase the uniformity and controllability of the heating process for the wafer W. In the present embodiment, the microwave units 30 are respectively connected to the microwave introduction ports 10. In other words, the number of the microwave units 30 is four.

The magnetron 31 has an anode and a cathode (both not shown) to which a high voltage supplied by the high voltage power supply unit 40 is applied. As for the magnetron 31, one capable of oscillating microwaves of various frequencies may be used. As for the frequency of the microwaves generated by the magnetron 31, an optimal frequency for the processing of an object is selected. For example, in a heating process, the microwaves having a high frequency of 2.45 GHz, 5.8 GHz or the like are preferably used and more preferably, the microwaves having a frequency of 5.8 GHz are used.

The waveguide 32 has a tubular shape with a rectangular cross section and extends upward from the top surface of the ceiling wall 11 of the processing chamber 2. The magnetron 31 is connected to an upper end portion of the waveguide 32. The lower end of the waveguide 32 comes into contact with the top surface of the transmitting window 33. The microwaves generated by the magnetron 31 are introduced into the processing chamber 2 through the waveguide 32 and the transmitting window 33.

The transmitting window 33 is made of a dielectric material, e.g., quartz, ceramic or the like. The space between the transmitting window 33 and the ceiling wall 11 is airtightly sealed by a sealing member (not shown).

The microwave introducing unit 30 further includes a circulator 34, a detector 35, and a tuner 36 which are provided on the waveguide 32; and a dummy load 37 connected to the circulator 34. The circulator 34, the detector 35 and the tuner 36 are provided in that order from the upper end side of the waveguide 32. The circulator 34 and the dummy load 37 serve as an isolator for separating reflected waves from the processing chamber 2. In other words, the circulator 34 transmits the reflected waves from the processing chamber 2 to the dummy load 37, and the dummy load 37 converts the reflected waves transmitted by the circulator 34 into heat.

The detector 35 detects the reflected waves from the processing chamber 2 in the waveguide 32. The detector 35 includes, e.g., an impedance monitor, specifically a standing wave monitor for detecting an electric field of the standing waves in the waveguide 32. The standing waves monitor may include, e.g., three pins protruding into the inner space of the waveguide 32. The standing waves monitor detects a location, a phase and an intensity of the electric field of the standing waves, thereby detecting the reflected waves from the process chamber 2. Further, the detector 35 may include a directional coupler capable of detecting traveling waves and reflected waves.

The tuner 36 has a function of matching an impedance between the magnetron 31 and the processing chamber 2. The tuner 36 performs the impedance matching based on the detection result of the reflected waves by the detector 35. The tuner 36 may include, e.g., a conductor plate (not shown) provided to protrude into and retract from the inner space of the waveguide 32. In that case, by controlling the protruding amount of the conductor plate into the inner space of the waveguide 32, the power amount of the reflected waves can be adjusted and, further, the impedance between the magnetron 31 and the processing chamber 2 can be adjusted.

(High Voltage Power Supply Unit)

The high voltage power supply unit 40 supplies a high voltage for generating microwaves to the magnetron 31. As shown in FIG. 5, the high voltage power supply unit 40 includes an AC-DC conversion circuit 41 connected to a commercial power source; a switching circuit 42 connected to the AC-DC conversion circuit 41; a switching controller 43 for controlling an operation of the switching circuit 42; a step-up transformer 44 connected to the switching circuit 42; and a rectifying circuit 45 connected to the step-up transformer 44. The magnetron 31 is connected to the step-up transformer 44 through the rectifying circuit 45.

The AC-DC conversion circuit 41 is a circuit which rectifies AC (e.g., three-phase 200V AC) from the commercial power source and converts it into DC of a predetermined waveform. The switching circuit 42 controls on/off of the DC converted by the AC-DC conversion circuit 41. In the switching circuit 42, the switching controller 43 performs phase-shift PWM (Pulse Width Modulation) control or PAM (Pulse Amplitude Modulation) control to generate a pulse-shaped voltage waveform. The step-up transformer 44 boosts the voltage waveform outputted from the switching circuit 42 to a predetermined level. The rectifying circuit 45 rectifies the voltage boosted by the step-up transformer 44 and supplies the rectified voltage to the magnetron 31.

(Control Unit)

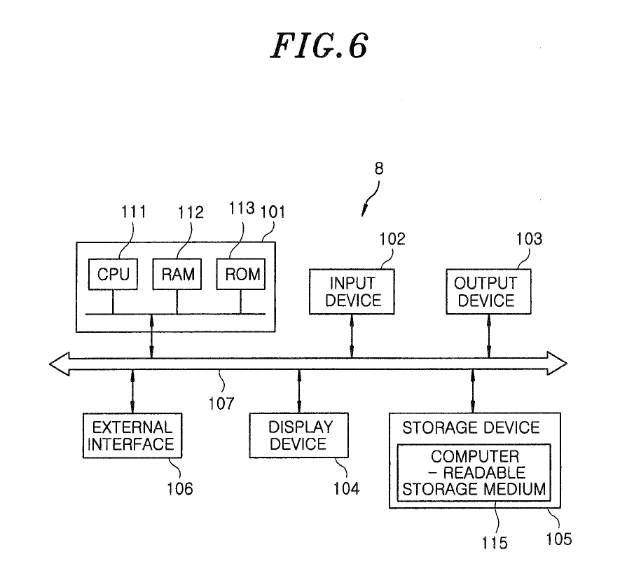

Each of the components of the microwave heating apparatus 1 is connected to the control unit 8 and controlled by the control unit 8. The control unit 8 is typically a computer. FIG. 6 shows an example of a hardware configuration of the control unit 8 shown in FIG. 1. The control unit 8 includes: a main controller 101; an input device 102 such as a keyboard, a mouse, or the like; an output device 103 such as a printer or the like; a display device 104; a storage device 105; an external interface 106; and a bus 107 that connects each of these devices. The main controller 101 includes a CPU (central processing unit) 111, a RAM (Random Access Memory) 112 and a ROM (Read Only Memory) 113.

The storage device 105 may be of any type as long as information can be stored. For example, the storage device 105 may be a hard disk device or an optical disk device. The storage device 105 is configured to store information in a computer-readable storage medium 115 and read out the information from the storage medium 115. The storage medium 115 may be of any type as long as information can be stored. For example, the storage medium 115 may be a hard disk, an optical disk, a flash memory or the like. The storage medium 115 may be a storage medium in which the recipe of the microwave heating method in accordance with the present embodiment is stored.

In the control unit 8, the CPU 111 uses the RAM 112 as a work area and executes the program stored in the ROM 113 or the storage device 105. Accordingly, the heating process for the wafer W in the microwave heating apparatus 1 in accordance with the present embodiment can be performed. Specifically, the control unit 8 controls the components (e.g., the microwave introducing unit 3, the supporting unit 4, the gas supply unit 5a, the gas exhaust unit 6, and the like) of the microwave heating apparatus 1 which are related to the processing conditions such as a temperature, a pressure in the processing chamber 2, a gas flow rate, a microwave output, a rotation speed of the wafer W and the like.

The microwave heating apparatus 1 configured as described above can perform a uniform heating process by suppressing the variation of the heating temperature in the surface of the wafer W.

The microwave heating apparatus 1 is preferably used for, e.g., a heating process for activating doping atoms implanted into the diffusion layer or the like in the manufacturing process of semiconductor devices.

[Microwave Heating Method]

Hereinafter, the microwave heating method according to embodiments performed by the microwave heating apparatus 1 will be described.

### First Embodiment

First, a microwave heating method in accordance with a first embodiment performed by the microwave heating apparatus 1 will be described. In the present embodiment, a command for performing the heating process in the microwave heating apparatus 1 is first inputted from the input device 102 of the control unit 8, for example. Next, the main controller 101 receives the command and reads out the recipes stored in the storage device 105 or the ROM 113. Then, the control unit 101 transmits control signals to the end devices (e.g., the microwave introducing unit 3, the supporting unit 4, the gas supply unit 5a, the gas exhaust unit 6 and the like) of the microwave heating apparatus 1 such that the heating process is performed under the conditions based on the recipes.

Next, the gate valve GV is opened, and the wafer W is loaded into the processing chamber 2 through the gate valve GV and the loading/unloading port 12a by a transfer unit (not shown). The wafer W is mounted on the supporting pins 16 of the holder 15.

The elevation driving unit 18 is driven, so that the holder 15 is vertically moved together with the shaft 14 to set the wafer W to a predetermined vertical position. In the present embodiment, the wafer W is set to the vertical position in which the distance H1 from the top surface of the bottom wall 13 to the backside of the wafer W satisfies the condition of H1<λ/2 and the distance H2 from the bottom surface of the ceiling wall 11 to the top surface of the wafer W satisfies the condition of 3λ/4≦H2<λ, λ being a wavelength of the microwave. This vertical position corresponds to the first vertical position in the disclosure.

At the first vertical position, the distance H1 satisfies the condition of H1<λ/2. Thus, at the temperature range of, e.g., 400° C. or above, the standing waves in the vertical direction of the processing chamber 2 can be prevented from being generated in the space S2 below the wafer W. In the present embodiment, the variation of the standing waves in the space S2 below the wafer W can be prevented by preventing the standing waves in the vertical direction from being generated in the space S2 below the wafer W.

Further, at the first vertical position, the distance H2 satisfies the condition of 3λ/4≦H2<λ. Therefore, at the temperature range of, e.g., 400° C. or above, a single standing wave in the vertical direction is allowed to be generated in the space S1 above the wafer W. Accordingly, the microwaves introduced through the microwave introduction ports 10 of the ceiling wall 11 are effectively irradiated toward the wafer W in the space S1 above the wafer W. Further, by setting the distance H2 to satisfy the condition of 3λ/4≦H2<λ, the wavelength of the standing wave in a direction parallel to the top surface of the wafer W can be shortened. As a result, the uniformity of the heating temperature in the surface of the wafer W can be improved.

The variation of the standing waves in the spaces above and below the wafer W deteriorates the uniformity of the heating uniformity in the surface of the wafer W. At the first vertical position, the behavior of the standing waves in the spaces above and below the wafer W is controlled so that the variation of the standing waves is suppressed. Accordingly, the uniformity of the heating temperature in the surface of the wafer W can be improved.

At the first vertical position, it is preferable to rotate the wafer W in a horizontal plane at a predetermined speed by driving the rotation driving unit 17, if necessary. The wafer W may not be rotated continuously, i.e., may be rotated discontinuously. Thereafter, the gate valve GV is closed, and the processing chamber 2 is vacuum-evacuated by the gas exhaust unit 6, if necessary. Next, a processing gas is introduced at a predetermined flow rate into the processing chamber 2 by the gas supply unit 5a. The inner space of the processing chamber 2 is controlled to a predetermined pressure by adjusting a gas exhaust amount and a gas supply amount.

Thereafter, microwaves are generated by applying a voltage from the high voltage power supply unit 40 to the magnetron 31 under the control of the control unit 8. The microwaves generated by the magnetron 31 are transmitted through the waveguide 32 and the transmitting window 33, and introduced into the space above the wafer W in the processing chamber 2. For example, microwaves are sequentially generated by the magnetrons 31 and introduced alternately into the processing chamber 2 through each of the microwave introduction ports 10. Alternatively, the microwaves may be simultaneously generated by the magnetrons 31 and simultaneously introduced into the processing chamber 2 through the microwave introduction ports 10.

The microwaves introduced into the processing chamber are irradiated onto the wafer W, and the wafer W is rapidly heated by electromagnetic wave heating such as Joule heating, magnetic heating, inductive heating or the like. As a result, the heating process is performed on the wafer W. In the microwave heating apparatus 1 of the present embodiment, the heating process can be uniformly performed in the surface of the wafer W by setting the wafer W to a vertical position in which the distance H1 from the top surface of the bottom wall 13 to the backside of the wafer W satisfies the condition of H1<λ/2 and the distance H2 from the bottom surface of the ceiling wall 11 to the top surface of the wafer W satisfies the condition of 3Δ/4≦H2<λ.

In the case of rotating the wafer W during the heating process, non-uniform distribution of the microwave irradiated onto the wafer W in the circumferential direction of the wafer W is reduced and, thus, the heating temperature in the surface of the wafer W can become uniform. The wafer W may not be rotated continuously, i.e., may be rotated discontinuously. The processing chamber 2 may be vacuum-evacuated by the gas exhaust unit 6, if necessary. Further, a processing gas may be introduced into the processing chamber 2 by the gas supply unit 5a, if necessary. The inner space of the processing chamber 2 is controlled to a predetermined pressure by adjusting a gas exhaust amount and a supply amount of the processing gas.

When a control signal for completing the heating process is transmitted from the main controller 101 to the end devices of the microwave heating apparatus 1, the generation of the microwaves and the rotation of the wafer W are stopped and the supply of the processing gas is stopped. In this manner, the heating process for the wafer W is completed.

After the heating process is performed for a predetermined period of time or after the cooling process following after the heating process is completed, the gate valve GV is opened. The vertical position of the wafer W is adjusted by the supporting unit 4 and the wafer W is unloaded by the transfer unit (not shown).

As described above, in the microwave heating method in accordance with the present embodiment, the heating process is performed by irradiating the microwaves onto the wafer W held at a predetermined vertical position. Therefore, the effect of the variation of the standing waves is reduced and the heating process can be uniformly performed in the surface of the wafer W.

### Second Embodiment

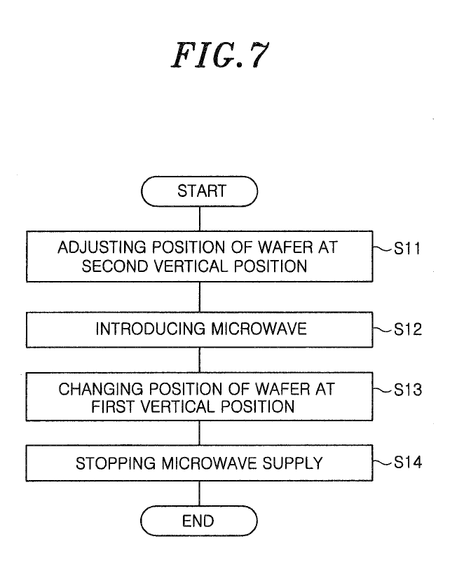

Hereinafter, a microwave heating method according to a second embodiment performed by the microwave heating apparatus 1 will be described. FIG. 7 is a flowchart showing an exemplary sequence of the microwave heating method of the present embodiment. The microwave heating method of the present embodiment includes steps S11 to S14 as shown in FIG. 7.

In the present embodiment, a command for performing the heating process in the microwave heating apparatus 1 is inputted from the input device 102 of the control unit 8, for example. Next, the main controller 101 receives the command and reads out the recipes that have been stored in the storage device 105 or the ROM 113. Then, the main controller 101 transmits control signals to the end devices (e.g., the microwave introducing unit 3, the supporting unit 4, the gas supply unit 5a, the gas exhaust unit 6 and the like) of the microwave heating apparatus 1 such that the heating process is performed under the conditions based on the recipes. Next, the gate valve GV is opened, and the wafer W is loaded into the processing chamber 2 through the gate valve GV and the loading/unloading port 12a by the transfer unit (not shown). The wafer W is mounted on the supporting pins 16 of the holder 15.

(Step S11)

First, in a step S11, the wafer W is adjusted to a predetermined vertical position by vertically moving the holder 15 holding the wafer W by the elevation driving unit 18 of the supporting unit 4. Preferably, this vertical position is different from the first vertical position as will be described in a step 13. In the microwave heating method in accordance with the present embodiment, the wafer W can be set to the intermediate position (H1=H2) in which the distance H1 from the top surface of the bottom wall 13 to the backside of the wafer W becomes equal to the distance H2 from the bottom surface of the ceiling wall 11 to the top surface of the wafer W. This vertical position corresponds to the second vertical position in the present disclosure.

At the second vertical position, the wafer W can be set to be at the position of the antinode of the standing wave where the electric field intensity is strong in the electromagnetic wave distribution in the processing chamber 2 at the temperature range from, e.g., a room temperature to 400° C. Hence, the dielectric heating effect of the wafer W can be improved.

(Step S12)

Next, in a step S12, the microwaves are introduced into the processing chamber 2 by the microwave introducing unit 3 in a state where the wafer W is held at the second vertical position. Then, the heating process is performed by irradiating the microwaves onto the wafer W held at the second vertical position. Specifically, the microwaves are generated by applying a voltage from the high voltage power supply unit 40 to the magnetron 31 under the control of the control unit 8. The microwaves generated by the magnetron 31 are transmitted through the waveguide 32 and the transmitting window 33, and introduced into the space above the rotating wafer W in the processing chamber 2. In the present embodiment, microwaves are sequentially generated by the magnetrons 31 and introduced alternately into the processing chamber 2 through each of the microwave introduction ports 10. Alternatively, the microwaves may be simultaneously generated by the magnetrons 31 and simultaneously introduced into the processing chamber 2 through the microwave introduction ports 10.

The microwaves introduced into the processing chamber 2 are irradiated onto the wafer W, and the wafer W is rapidly heated by electromagnetic wave heating such as Joule heating, magnetic heating, inductive heating or the like. As a result, the heating process is performed on the wafer W.

During the heating process, non-uniform distribution of the microwaves irradiated to the wafer W is reduced by rotating the wafer W. Accordingly, the heating temperature in the surface of the wafer W can become uniform. The wafer W may not be rotated continuously, i.e., may be rotated discontinuously. If necessary, the processing chamber 2 may be vacuum-evacuated by the gas exhaust unit 6. Further, if necessary, a processing gas may be introduced into the processing chamber 2 by the gas supply unit 5a. The inner space of the processing chamber 2 may be controlled to a predetermined pressure by adjusting a gas exhaust amount and a supply amount of the processing gas.

(Step S13)

In a step S13, in a state where the microwaves are irradiated to the wafer W, the vertical position of the wafer W is changed from the second vertical position to the first vertical position by moving the holder 15 by driving the elevation driving unit 18. At the first vertical position, the distance H1 satisfies the condition of H1<λ/2. Thus, at the temperature range of, e.g., 400° C. or above, the standing waves in the vertical direction of the processing chamber 2 can be prevented from being generated in the space S2 below the wafer W. Therefore, the variation of the standing waves in the space S2 below the wafer W can be prevented.

At the first vertical position, the distance H2 satisfies the condition of 3λ/4≦H2<λ. Therefore, at the temperature range of, e.g., 400° C. or above, a single standing wave in the vertical direction is allowed to be generated in the space S1 above the wafer W. Accordingly, the microwaves introduced through the microwave introduction ports 10 of the ceiling wall 11 are effectively irradiated toward the wafer W in the space S1 above the wafer W. By setting the distance H2 to satisfy the condition of 3λ/4≦H2<λ, the wavelength of the standing waves in a direction parallel to the top surface of the wafer W is shortened. As a result, the uniformity of the heating temperature in the surface of the wafer W can be improved.

The timing at which the step S12 is shifted to the step S13 (i.e., the timing at which the position of the wafer W is changed from the second vertical position to the first vertical position) can be determined based on, e.g., the temperature of the wafer W measured by the temperature measurement unit 27. Specifically, the main controller 101 of the control unit 8 monitors measured temperature information of the temperature measurement unit 27 and transmits to the elevation driving unit 18 a control signal that allows the step S12 to be shifted to the step S13 when the temperature of the wafer W reaches a predetermined temperature range.

Shifting from the step S12 to the step S13 may be determined by, e.g., a time preset based on wafer temperature measurement data obtained from a test. It is preferable to shift the step S12 to the step S13 when a temperature of the wafer W is, e.g., 400° C. or above, preferably 400° C. to 600° C., and more preferably 400° C. to 500° C. At the temperature range of 400° C. or above, silicon forming the wafer W functions as a conductor and, therefore, the surface of the wafer W serves as a reflective surface. Therefore, in the processing chamber 2, the behavior of the microwaves in the space S1 above the wafer W is different from that in the space S2 below the wafer W. At the first vertical position, the generation of the standing waves in the vertical direction in the space S2 below the wafer W can be suppressed and, thus, the variation of the standing waves can be prevented.

Further, at the first vertical position, the wavelength of the standing waves in a direction parallel to the top surface of the wafer W is shortened in the space S1 above the wafer W, so that the uniformity of the heating temperature in the surface of the wafer W can be improved. Hence, when the temperature of the wafer W is 400° C. or above, the uniformity of the heating temperature in the surface of the wafer W can be improved by changing the vertical position of the wafer W to the first vertical position. When the temperature of the wafer W is lower than 400° C., silicon forming the wafer W hardly serves as a conductor and, thus, most of the microwaves transmit the wafer W. Accordingly, the standing waves generated in the upper space S1 and the lower space S2 and the distribution thereof are different from those obtained when the temperature of the wafer W is 400° C. or above. As a result, the vertical position of the wafer W at the temperature range in which silicon serves as a conductor greatly affects the uniform processing in the surface of the wafer W.

Processing conditions in the step S13 are the same as those in the step S12 except for that the vertical position of the wafer W is changed to the first vertical position.

(Step S14)

Next, the supply of the microwaves is stopped in the step S14. For example, the control signals for completing the heating process are transmitted from the main controller 101 to each of the end devices of the microwave heating apparatus 1. Accordingly, the generation of the microwaves is stopped and the rotation of the wafer W is stopped. Further, the supply of the processing gas is stopped. In this manner, the heating process for the wafer W is completed.

After the heating process is performed for a predetermined period of time or after the cooling process following after the heating process is completed, the gate valve GV is opened. The vertical position of the wafer W is adjusted by the supporting unit 4 and the wafer W is unloaded by the transfer unit (not shown).

As described above, in the microwave heating method in accordance with the present embodiment, the vertical position of the wafer W is changed during the heating process in which microwaves are irradiated onto the wafer W. Accordingly, the behavior of the standing waves in the processing chamber 2 is controlled and the heating process can be performed on the wafer W while effectively using the microwaves. Particularly, when the temperature of the wafer W is lower than 400° C., the heating process is performed at the second vertical position and when the temperature of the wafer W is 400° C. or above, the heating process is performed at the first vertical position changed from the second vertical position. As a result, it is possible to realize both of the improvement of the dielectric heating effect and the processing uniformity in the surface of the wafer W. The vertical position of the wafer W may be changed to three or more positions without being limited to two positions. When the vertical position of the wafer W is changed, the supply of the microwaves may be stopped.

(Effects)

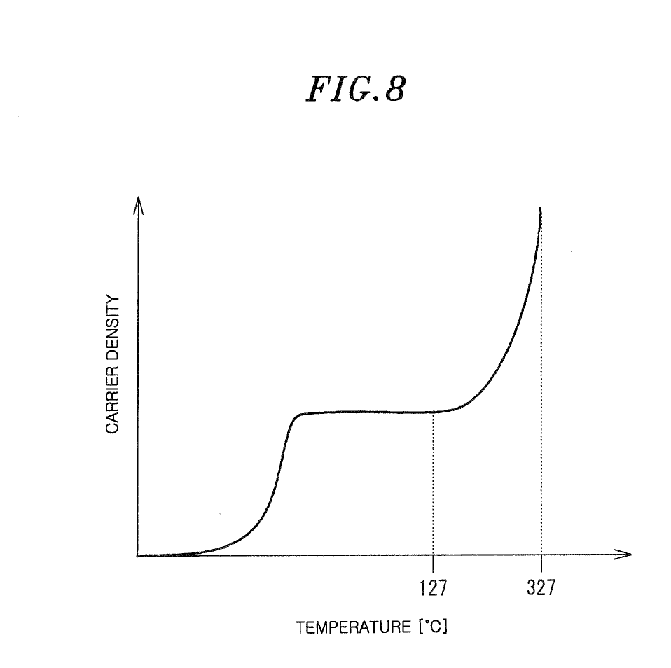

Hereinafter, the effects of the disclosure will be described with reference to FIGS. 8 to 11. FIG. 8 is a graph showing a change of a carrier density during a heating process of increasing a temperature of a silicon substrate doped with a dopant at a general concentration. Generally, an electric conductivity of a semiconductor is increased as a temperature is increased. In the graph of FIG. 8, a temperature range from a room temperature to 127° C. is a saturated region where the conductivity is constant. A temperature range higher than 127° C. becomes an intrinsic region due to increase in electric conductivity caused by considerable increase in the amount of carriers. Therefore, it is considered that a conductive property of silicon forming the wafer W is enhanced at the temperature range of 400° C. or above.

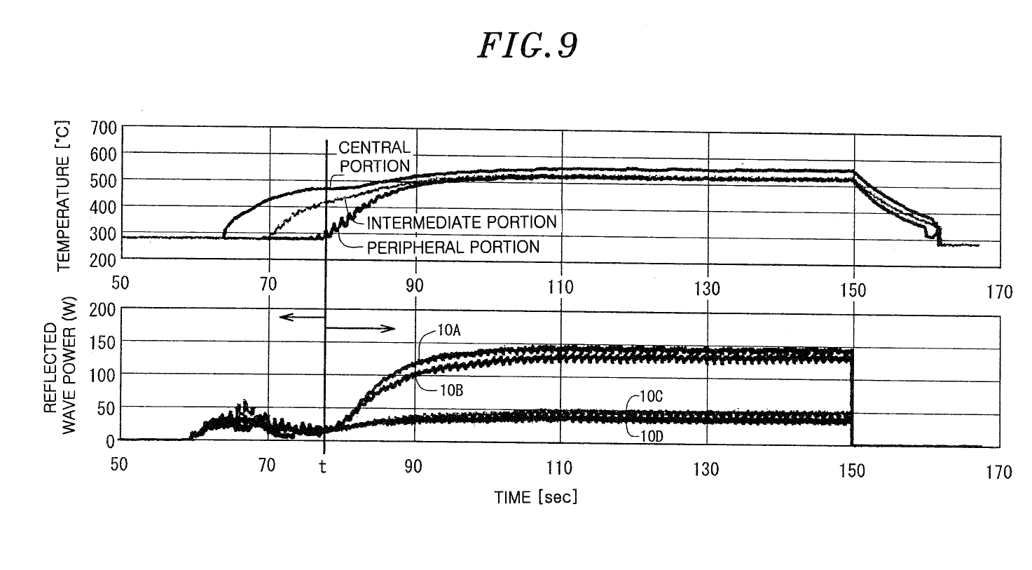

FIG. 9 shows changes of a wafer temperature and a reflected wave power in the case of heating the wafer W by the microwave heating apparatus 1 having the same configuration as that shown in FIG. 1. In this test, microwaves having a frequency of 5.8 GHz were generated at an output of 1000 W by four magnetrons 31 and introduced into the processing chamber 2 from the microwave introduction ports 10. Then, the temperature of the wafer W and the power of the reflected wave transmitted to each of the microwave introduction ports 10 were measured.

The upper graph in FIG. 9 shows changes of temperatures of a central portion of the wafer W, a peripheral portion of the wafer W and an intermediate portion of the wafer W between the central portion and the peripheral portion. The lower graph in FIG. 9 shows the power of the reflected wave transmitted to the four microwave introduction ports 10 (In FIG. 9, the microwave introduction ports are denoted by 10A, 10B, 10C, and 10D). As can be seen from FIG. 9, the behavior of the reflected wave is considerably changed at the timing denoted by the notation “t” while the temperature of the wafer W is increased from 300° C. to 500° C. for 15 sec to 20 sec from the start of the temperature increase (the timing at which a reflected wave power is generated). This shows that silicon forming the wafer W functions as a conductor when the wafer temperature exceeds 400° C.

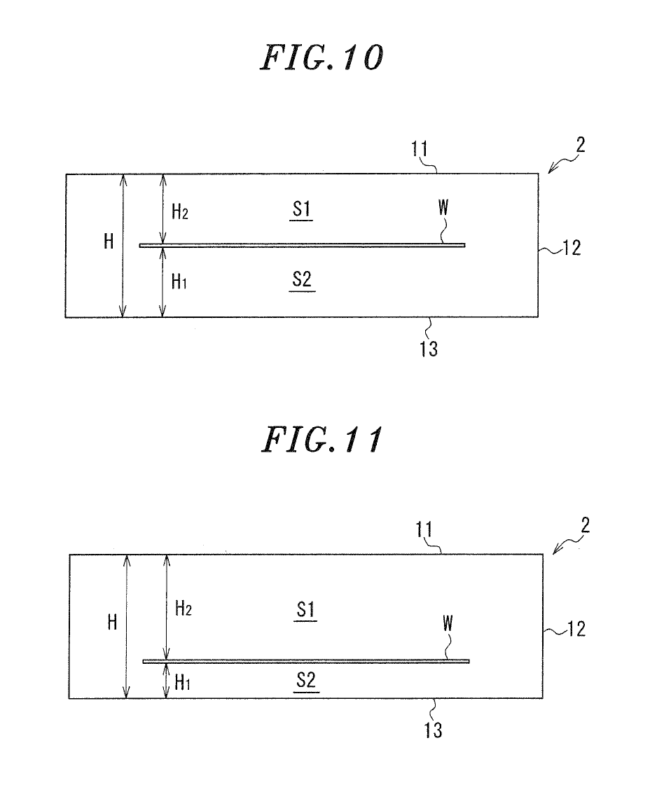

The processing chamber 2 is surrounded by the ceiling wall 11, the sidewall 12, and the bottom wall 13. Therefore, the microwaves introduced into the processing chamber 2 generate standing waves in a direction parallel to the top surface or the rear surface of the wafer W and in a vertical direction of the processing chamber 2. When the temperature of the wafer W is lower than 400° C., silicon forming the wafer W serves as a semiconductor. Therefore, the microwaves transmit the wafer W and a single standing wave having a wavelength equal to the height H of the processing chamber is generated in the vertical direction of the processing chamber 2. Accordingly, when the temperature of the wafer W is lower than 400° C., the intermediate position between the ceiling wall 11 and the bottom wall 13 in the processing chamber 2 becomes a position of an antinode where the electric field is strong. As a result, the dielectric heating efficiency of the wafer W can be maximized by setting the vertical position of the wafer W at the intermediate position in which the distance H1 is equal to the distance H2 as shown in FIG. 10, for example.

On the other hand, when the temperature of the wafer W is higher than or equal to 400° C., the wafer W serves as a metal with respect to microwaves having a frequency of, e.g., 5.8 GHz. Therefore, the wafer W serves as a metallic boundary and the microwaves are reflected. Accordingly, standing waves are generated in the space S1 above the wafer W and in the space S2 below the wafer W. When the standing waves in the vertical direction are generated in the space S2 below the wafer W, the variation of the standing waves easily occurs due to the shaft 14 or the arms 15b of the holder 15 disposed below the wafer W, which may deteriorate the uniformity of the heating temperature in the surface of the wafer W. In the microwave heating apparatus 1 in accordance with the present embodiment, the wafer W is set to the first vertical position in which the condition of H1<λ/2 is satisfied as shown in FIG. 11 in order to prevent the standing waves in the vertical direction from being generated in the lower space S2. As a consequence, the variation of the standing waves is prevented. Specifically, in the case of using a microwave having a frequency of 5.8 GHz, the vacuum wavelength λ is 51.7 mm. Thus, the distance H1 may be set to be smaller than 25.84 mm.

At the first vertical position in which the condition of 3λ/4≦H2<λ is satisfied, a single standing wave in the vertical direction is allowed to be generated in the space S1 above the wafer W. As a consequence, the direction of the electric field of the microwaves introduced through the microwave introduction ports 10 of the ceiling wall 11 becomes close to the vertical direction of the processing chamber 2. Hence, the microwaves are effectively irradiated toward the wafer W. By satisfying the condition of 3λ/4≦H2<λ, it is possible to shorten the wavelength of the standing waves in a direction parallel to the top surface of the wafer W. Accordingly, the uniformity of the heating temperature in the surface of the wafer W can be improved. Specifically, in the case of using a microwave having a frequency of 5.8 GHz, the distance H2 may be set to be equal to or greater than 38.77 mm and less than 51.7 mm.

The disclosure may be variously modified without being limited to the above-described embodiments. For example, the number of the microwave units 30 (the number of the magnetrons 31) and the number of the microwave inlet ports 10 in the microwave heating apparatus is not limited to that in the above embodiments.

While the disclosure has been shown and described with respect to the embodiments, it will be understood by those skilled in the art that various changes and modifications may be made without departing from the scope of the disclosure as defined in the following claims.

What is claimed is:

1. A microwave heating apparatus comprising:
a processing chamber configured to accommodate a target object, the processing chamber including a ceiling wall, a bottom wall in parallel with the ceiling wall, and a sidewall;
a microwave introducing unit including one or more microwave introduction ports formed at the ceiling wall and configured to generate a microwave for heating the target object and to introduce the microwave into the processing chamber through the one or more microwave introduction ports;
a holding unit configured to hold the target object to be opposite to the ceiling wall in the processing chamber; and
a control unit configured to control the microwave introducing unit to heat the target object while controlling the holding unit to hold the target object at one vertical position in which a first distance H1 from the top surface of the bottom wall to the bottom surface of the target object satisfies a condition of H1<λ/2, and a second distance H2 from the bottom surface of the ceiling wall to the top surface of the target object satisfies a condition of 3λ/4≦H2<λ, λ being a wavelength of the microwave.

2. The microwave heating apparatus of claim 1, further comprising a vertical position adjusting unit configured to vertically move the holding unit,
wherein the control unit is further configured to control the vertical position adjusting unit such that the holding unit holding the target object is vertically moved to the one vertical position from another vertical position with the target object being heated by the microwave introducing unit.

3. The microwave heating apparatus of claim 2, further comprising a temperature measurement unit configured to measure a temperature of the target object held by the holding unit,
wherein the control unit is further configured to allow the vertical position adjusting unit to vertically move the holding unit holding the target object from the another vertical position to the one vertical position based on the measured temperature of the target object.

4. The microwave heating apparatus of claim 3, wherein the target object is a silicon substrate, and
wherein the control unit is further configured to allow the vertical position adjusting unit to vertically move the holding unit holding the target object from the another vertical position to the one vertical position when the temperature of the silicon substrate is 400° C. or more.

5. The microwave heating apparatus of claim 1, wherein the holding unit is configured to hold the target object while being in contact therewith.

6. The microwave heating apparatus of claim 2, wherein, at the another vertical position, the first distance H1 is equal to the second distance H2.

7. A microwave heating method for use in heating a target object in a processing chamber including a ceiling wall and a bottom wall in parallel to the ceiling wall, the microwave heating method comprising:
heating the target object while holding the target object at one vertical position in which a first distance H1 from a top surface of the bottom wall to a bottom surface of the target object satisfies a condition of H1<λ/2, and a second distance H2 from a bottom surface of the ceiling wall to a top surface of the target object satisfies a condition of 3λ/4≦H2<λ, λ being a wavelength of the microwave.

8. The microwave heating method of claim 7, further comprising moving the target object vertically to the one vertical position from another vertical position with the target object being heated.

9. The microwave heating method of claim 8, further comprising measuring a temperature of the target object,
wherein when the moving is started is determined based on a measured temperature of the target object.

10. The microwave heating method of claim 9, wherein the target object is a silicon substrate, and
wherein the moving is started when a temperature of the silicon substrate is 400° C. or more.

11. The microwave heating method of claim 8, wherein, at the another vertical position, the first distance H1 is equal to the second distance H2.
